(19) United States
(12) Patent Application Publication
(10) Pub. No.: US 2010/0201665 A1
(43) Pub. Date: Aug. 12, 2010

(54) Display Device Including a Liquid Crystal Screen with Secured Display

(75) Inventors: Philippe Airault, Lege (FR); Laurent Canal, Merignac (FR); Gerard Voisin, St. Medard en Jalles (FR)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: THALES, Neuilly-sur-Seine (FR)

(21) Appl. No.: 12/676,901

(22) PCT Filed: Aug. 25, 2008
(86) PCT No.: PCT/EP08/61067

§ 371 Date: Mar. 17, 2010

(30) Foreign Application Priority Data
Sep. 7, 2007 (FR) 0706283

(51) Int. Cl. G06F 3/038

(52) U.S. Cl. 345/208; 345/94

(57) ABSTRACT

The general field of the invention is that of display devices comprising a liquid-crystal matrix screen composed of elementary pixels, said screen comprising at least a first electrode used as voltage reference and called the “backplane”, a second electrode in the form of a matrix electronic network delivering the drive voltages for controlling the pixels and control electronics for said electrodes, said screen being used in the so-called “normally black” mode, that is to say that in the absence of applied voltages, the optical transmission of the pixels is substantially zero. In the device according to the invention, the “backplane” drive voltage is a variable periodic voltage, the amplitude of variation of this voltage being sufficient so that in the absence of voltage on the second electrode, the optical transmission of the pixels is sufficient to be detected by an observer.

The field of the invention is that of liquid-crystal flat screens requiring a high degree of security.

In the aeronautical field, safety constitutes one of the fundamental parameters. Having regard to increases in air traffic, aircraft manufacturers and airline companies are imposing ever more ambitious objectives on equipment manufacturers. In the field of cockpit displays, any display of erroneous images is henceforth prohibited.

For many years, liquid-crystal flat screens have been prevalent in the field of displays. They are, inter alia, used to effect the displays of aircraft instrument panels.

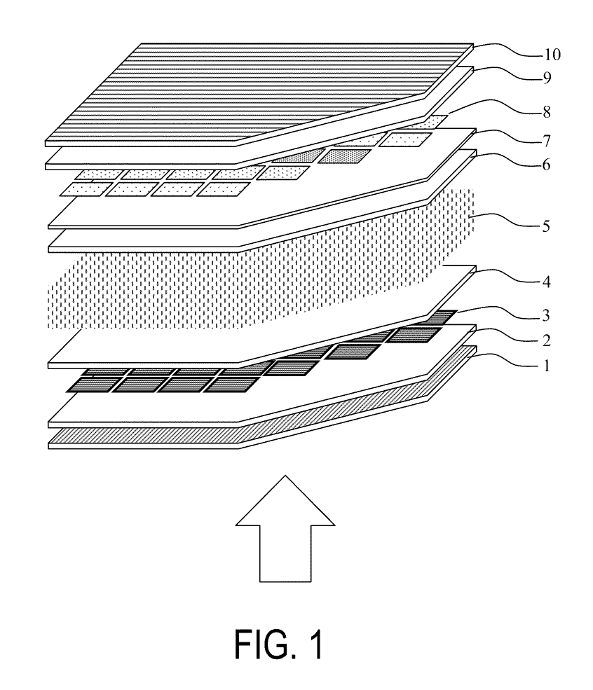

Conventionally, a liquid-crystal display, termed LCD, essentially comprises a lighting source and a matrix-like optical modulator. The matrix proper is a pane composed of a stack of various layers. FIG. 1 represents a partial exploded view of an LCD matrix. In this view, the white arrow indicates the direction of propagation of the light through the matrix. The latter comprises in succession:
A first rear polarizer 1 disposed on the lighting source side;
A first glass sheet 2 which comprises the matrix control electronics 3 composed mainly of a vertical control bus and of a vertical control bus, the control electronics commonly being called “drivers” according to the conventional terminology;
A first support plate 4 for the liquid crystal;
The liquid crystal 5;
A second support plate 6 for the liquid crystal bearing a counter-electrode also called the “backplane” 7;
A matrix network 8 of triples of colored filters. Each triple corresponds to a pixel also known by the term colored “dot” of the image;
A second glass sheet 9;
A second rear polarizer 10 disposed on the observer's side.

The display operates as follows. The light source is polarized at the rear of the pane by the first polarizer 1. The light passes through the liquid crystal, the colored filters 8 and emerges through the second polarizer 10. The polarization of the light is phase-shifted by 90 degrees when it passes through the liquid crystal whilst quiescent.

There are two chief possible operating modes. In the first mode, the polarization axis of the second polarizer is perpendicular to that of the first polarizer. In this case, the light issuing from the pane, after passing through the liquid crystal, has the same polarization state as the second polarizer and can emerge. This mode is called the “white mode” or else “normally white”. In the second mode, the polarization axis of the second polarizer is parallel to that of the first polarizer. In this case, the light issuing from the pane is polarized at 90 degrees to the polarization axis of the second polarizer and cannot emerge. This mode is called the “black mode” or else “normally black”.

In both cases, following the drive command applied to the liquid crystal, the light passing through the latter will be phase-shifted by it to a greater or lesser extent, and only a fraction of the light passes through the front polarizer as a function of the phase shift generated. Gray shades are thus created on each colored filter. It is thus possible to generate a pixel or a “dot” having a given color either in “normally white” mode or in “normally black” mode.

The first LCD screens used solely a structure termed “twisted nematic” or TN. This structure made it possible to produce LCD cells termed “normally white”. Not driven, the “dots” were luminous.

In the aeronautical field, the dots of colors were organized into quadruples called “quads” and column “drive” or control circuits, mounted interleaved, so-called “Stripe” mode, were used in order to cover the loss of a video link.

These cells used a drive mode called “backplane switching” to control the matrix.

Moreover, the first displays exhibited technological weaknesses. The liquid crystal had a low time constant and the amorphous silicon “MOS” transistors had sizeable current leakages.

Now, avionics graphical images generally use a dark background to improve the contrast of the plots. On the first LCD screens, a fault then created an abnormal luminous zone that the pilot detected immediately. Consequently, the technical characteristics of the first LCD displays readily allowed visual detection of faults in the display and the associated electronics. In conclusion, safety was ensured naturally.

Progress with liquid crystals, with column drivers and with the manufacture of active matrices has allowed the use of a drive mode of control called “fixed backplane”. The viewing angle of the matrices has been increased by introducing new structures and new configurations of matrices. So-called MVA matrices, the acronym standing for “Multi-domain Vertical Alignment” or IPS matrices, the acronym standing for “In Plane Switching”, will be cited by way of example. These new matrices are in “normally black” mode. The non-driven cell is therefore black. This therefore minimizes the effect of faulty pixels which are then predominantly black, contrary to “normally white” TN type matrices whose predominantly luminous defective pixels are abundantly evident.

Of course, these matrices which possess better optical performance are used in the aeronautical field. Unfortunately, these cosmetic or esthetic advantages introduce a complication as regards safety. With these new matrices, a fault creates a dark zone which may seem normal, whereas the useful information has disappeared. Thus, a fault with a video link may cause the loss of the red pixels. This fault makes the red alerts disappear and transforms the yellow and orange alerts into green-colored information. Moreover, faults with the “line drivers” of LCD matrices create frozen images which may have a remanence of the order of a minute and are therefore deemed unacceptable. These events are obviously strictly prohibited in aeronautical applications.

The device according to the invention makes it possible to solve or to greatly attenuate the above drawbacks, while preserving the advantages of the use of a “normally black” LCD display. To solve the safety problem, a percentage of switching of the “backplane” voltage is introduced into the LCD drive circuit.

More precisely, the subject of the invention is a display device comprising at least one liquid-crystal matrix screen composed of elementary pixels, said screen comprising at least a first electrode used as voltage reference and called the “backplane”, a second electrode in the form of a matrix electronic network delivering the drive voltages for controlling the pixels and control electronics for said electrodes, said screen being used in the so-called “normally black” mode, that is to say that in the absence of applied voltages, the optical transmission of the pixels is substantially zero, characterized in that the “backplane” drive voltage is a variable periodic voltage, the amplitude of variation of this voltage being sufficient so that in the absence of voltage on the second electrode, the optical transmission of the pixels is sufficient to be detected by an observer.

Advantageously, the drive voltage for controlling the pixels is periodic, the amplitude of variation of said voltage being centered on the “backplane” drive voltage in such a way that on average the pixel is subjected to a zero voltage.

Advantageously, the “backplane” drive voltage over a period has a first constant value during a first half-period and a second constant value, different from the first value, during a second half-period.

More precisely, the drive voltage for controlling the pixels has a maximum amplitude corresponding to a maximum optical transmission, said maximum amplitude being about three times greater than the amplitude of variation of the “backplane” voltage and the frequency of variation of the “backplane” drive voltage is of the same order of magnitude as the image refresh frequency, denoted frame frequency.

Finally, the liquid-crystal matrix screen is preferably of the MVA type, the acronym standing for “Multi-domain Vertical Alignment”, or the IPS type, the acronym standing for “In Plane Switching”.

The invention will be better understood and other advantages will become apparent on reading the nonlimiting description which follows and by virtue of the appended figures among which:

FIG. 1 represents a sectional view of an LCD matrix;

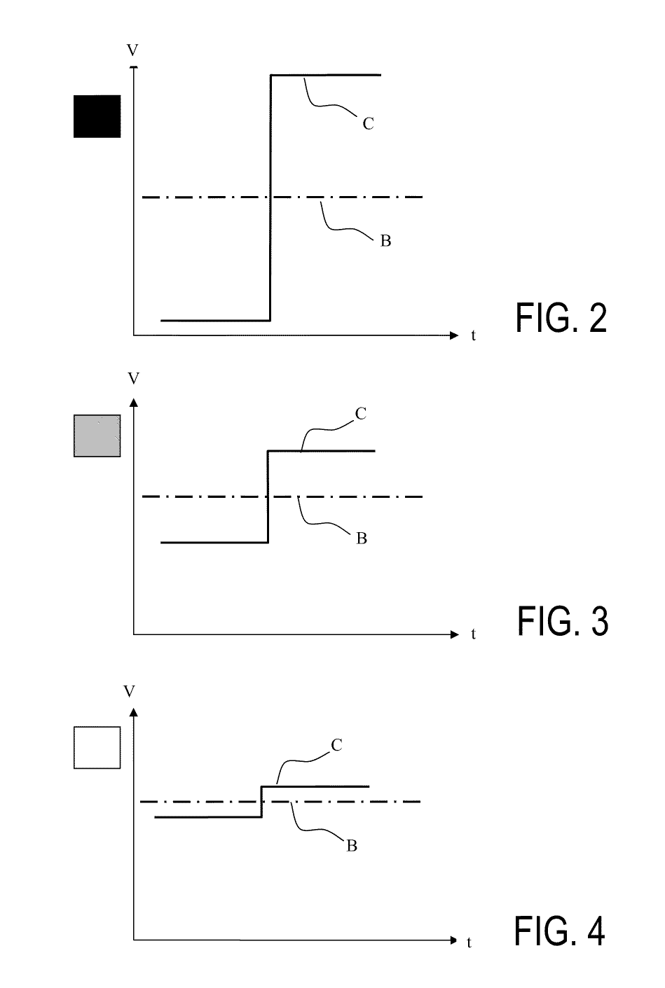

FIGS. 2, 3 and 4 represent the variation over time of the drive voltages for controlling the pixels in the case of a “normally white” LCD matrix according to the prior art;

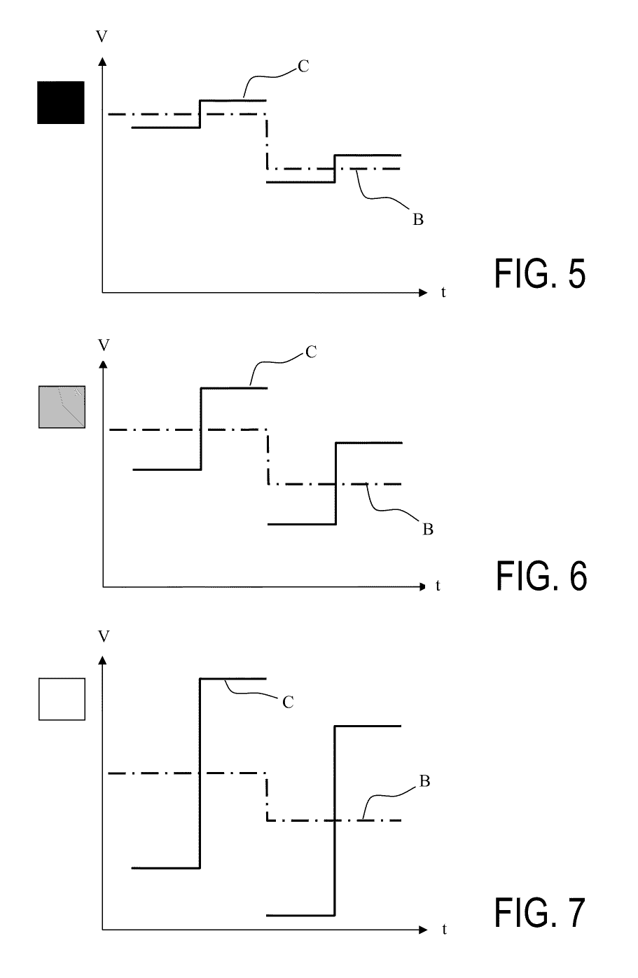

FIGS. 5, 6 and 7 represent the variation over time of the drive voltages for controlling the pixels in the case of a “normally black” LCD matrix according to the invention.

The figures numbered from 2 to 7 represent the variations as a function of time of the amplitude of the drive voltages for controlling the “backplane” B and the electrode C for controlling the pixels. The “backplane” drive voltage is represented chain-dotted and the electrode drive voltage is represented by a solid line. In the top left part of each figure, the transmission obtained is represented by a white, gray or black square.

FIGS. 2, 3 and 4 represent the variation over time of the drive voltages for controlling the pixels in the case of a “normally white” LCD matrix. As seen in these figures, the “backplane” voltage is constant. The drive voltage for controlling the pixels is in the form of a periodic notch. The maximum amplitudes of the voltages are of the order of 12 volts. Each notch is centered on the “backplane” voltage. Thus, the liquid crystal situated between the control electrode and the “backplane” sees a zero mean voltage. This therefore avoids marking the screen.

The amplitude of the notches dictates the transmission of the pixel. Thus, as illustrated in FIG. 2, a large amplitude generates a black pixel, a mean amplitude a gray pixel (FIG. 3) and a low amplitude a white pixel (FIG. 4).

FIGS. 5, 6 and 7 represent the variation over time of the drive voltages for controlling the pixels in the case of a “normally black” LCD matrix according to the invention. As seen in these figures, the “backplane” voltage is variable. The simplest variation to achieve and which is represented in these figures is to vary the voltage periodically between two constant voltage levels. The drive voltage for controlling the pixels is also in the form of a periodic notch. The maximum amplitudes of the voltages are of the order of 12 volts. Each notch is centered on the “backplane” voltage in such a way that the liquid crystal situated between the control electrode and the “backplane” sees a zero mean voltage, as seen in FIGS. 5, 6 and 7.

The amplitude of the notches dictates the transmission of the pixel. Thus, as illustrated in FIG. 5, a low amplitude generates a black pixel, a mean amplitude a gray pixel (FIG. 6) and a large amplitude a white pixel (FIG. 7).

The “backplane” switches at a low frequency which may be, for example, the frame frequency so as not to have any problems during electro-magnetic compatibility trials. Thus, the “backplane” voltage is not disturbed and in return, does not disturb. The drive voltages for controlling the pixels termed GMA, the acronym standing for “Gamma Modulation Amplitude”, are the sum of the variation of the backplane and of the voltage that one actually wishes to apply to the “dot”.

If the control electronics for driving the pixels is faulty, the origin of the fault possibly stemming either from the digital video, or from the GMA voltage generator, the switching of the “backplane” voltage suffices to drive the dot to gray. The background of the image is no longer black and the pilot detects the fault as in the past. Likewise, if the control circuit of the “backplane” is broken, the dots will all be controlled by the columns and none will be black. Of course, the device does not make it possible to compensate for simultaneous faults with the control electronics and with the “backplane”, but these simultaneous faults are highly improbable, given the very high level of reliability of the electronic components for controlling electronic displays for their use in the aeronautical field.

The proposed device makes it possible to ensure the safety of “normally black” LCD screens by reproducing the effects that were present in the past when a “normally white” matrix developed a fault. These effects are acceptable to aircraft manufacturers and aeronautical certification authorities.

The modifications to be made to the control software which consist essentially in having a variable “backplane” voltage instead of a fixed voltage are negligible and have no significant impacts either on the costs or on the reliability of the display device.

1. A display device comprising at least one liquid-crystal matrix screen composed of elementary pixels, said screen comprising at least a first electrode used as voltage reference and called the “backplane”, a second electrode in the form of a matrix electronic network delivering the drive voltages for controlling the pixels and control electronics for said electrodes, said screen being used in the so-called “normally black” mode, that is to say that the maximum amplitude of the drive voltage for controlling the pixels corresponds to a maximum optical transmission, wherein the “backplane” drive voltage is a variable periodic voltage, the amplitude of variation of the “backplane” voltage representing about a third of the maximum amplitude of the drive voltage for controlling the pixels, the amplitude of variation of this voltage being sufficient so that in the absence of voltage on the second electrode, the optical transmission of the pixels is sufficient to be detected by an observer.

2. The display device as claimed in claim 1, wherein the drive voltage for controlling the pixels is periodic, the amplitude of variation of said voltage being centered on the “backplane” drive voltage in such a way that on average the pixel is subjected to a zero voltage.

3. The display device as claimed in claim 1, wherein the “backplane” drive voltage over a period has a first constant value during a first half-period and a second constant value, different from the first value, during a second half-period.

4. The display device as claimed in claim 1, wherein the frequency of variation of the “backplane” drive voltage is of the same order of magnitude as the image refresh frequency, denoted frame frequency.

5. The display device as claimed in one of the preceding claims, wherein the liquid-crystal matrix screen is of the MVA type, the acronym standing for “Multi-domain Vertical Alignment”, or the IPS type, the acronym standing for “In Plane Switching”.
